(19) United States
(12) Patent Application Publication
(10) Pub. No.: US 2008/0243586 A1
(43) Pub. Date: Oct. 2, 2008

(54) RECRUITING ONLINE SURVEY PANEL MEMBERS UTILIZING A SURVEY TOOL

(76) Inventors: Doug Carl Dohring, Glendale, CA (US); Rik I. Kinney, Glendale, CA (US)

Correspondence Address: MERCHANT & GOULD PC, P.O. BOX 2903, MINNEAPOLIS, MN, 55402-0903, US

(21) Appl. No.: 11/692,103

(22) Filed: Mar. 27, 2007

(51) Int. Cl. G06F 17/30

(52) U.S. Cl. 705/10

(57) ABSTRACT

A survey tool, that may be a web-based or downloadable application, is provided to ordinary online users to enable them to create their own survey, quiz, test, poll, or similar item for posting on their website, blog, or social networking or community site page. The Internet user designs a survey utilizing the survey tool. The market research company allows the Internet user to post the results of at least one question from the survey designed by the Internet user on their own website, blog, social networking or community site page, etc. The market research company may invite the survey takers and survey viewers, as well as the Internet user, to join the market research company online survey panel through clicking on a link to the market research company's website. Thus, the market research company is able to add new members to its online survey panel with very little effort.

### BACKGROUND

The Internet has shown itself to be an effective tool for retailers and market researchers. Traditional methods of conducting market research, such as through scientific telephone polling and in-person interviews, can now be conducted through email surveys and websites that offer viewers the opportunity to take a survey or otherwise respond to an invitation to give their opinion on a particular topic or potential new product. The advantages of online research are many. Online survey responders are not interrupted with unwanted phone calls at inopportune times. Online survey responders are able to complete online surveys at their own convenience in the privacy of their own home or office. Many survey responders find that this is a very convenient and fun way to make their opinions known.

Some market research companies seek actively to recruit people via the Internet to become a part of an online survey panel, which is a database of individuals who have agreed to share their opinions by taking surveys from time to time via the Internet. The preferences, ideas, and opinions of an online survey panel can be very important in the development of new and existing products and services and in gathering useful information on key issues of commercial, social and/or political importance.

Market research companies make money by selling the ability to survey people readily, easily, and cost-effectively. The larger the survey panel, the more granular the potential targeting of the survey. Market research companies having a large number of survey panel members that reflect a broad range of demographics, interests, and needs are in a better position to effectively sell access to their panel members to third parties. For example, a client of a market research company may want to survey women with children who live in Michigan regarding laundry detergent. The market research companies need to have large enough survey panels so that a specific demographic segment such as this can be surveyed and yield results that can be relied upon by the interested third party.

Industry studies indicate that it can cost a market research company between one and three (or more) dollars to register each new survey panel member, who may or may not ultimately actively participate in surveys. Market research companies are continually trying to find people who are willing to take surveys, and who will follow through when contacted to take a survey. In light of the recent crackdown on spam email and anti-spam laws, as well as the enactment of more stringent privacy laws, the buying and selling of lists of names as a means of building up a survey panel has been greatly curtailed. As a result, it has become more difficult to contact people in the first instance, and it has become much more troublesome for interested people to register, often requiring one or more email exchanges between the interested person and the market research company. Experience has shown that the more difficult the registration process, the less likely a person is apt to register. Thus, in recent years, it has become much harder and more expensive for a marketing company to build up large survey panels. What is needed in the art is a new and expedient way for market research companies to find and recruit people to join their survey panels.

### SUMMARY

This Summary is provided to introduce in a simplified form a selection of concepts that are further described below in the Detailed Description. This Summary is not intended to identify key features or essential features of the claimed subject matter, nor is it intended to be used to limit the scope of the claimed subject matter.

A market research company provides a web-based application that allows ordinary Internet users who have their own website, blog, or who have a presence anywhere on the Internet (including but not limited to, social networking or community sites) to develop their own survey or survey results for posting online or publishing on other forms of media. The Internet user creates the survey utilizing the web based application. The survey created by the Internet user may be hosted on the market research company web server. In addition to posting an image or text link to the survey on the Internet user's website, blog, social networking or community site page, etc., the Internet user can also send the URL link for the survey, which may be hosted on the market research company web server, to their friends, family, colleagues, etc., in an email. The market research company may facilitate the Internet user's posting of the results of at least one question from the survey the Internet user created on their own website, blog, social networking or community site page, etc. in a graphic format. For example, people coming to Sally's social networking page can see the results of her survey question “Who is your favorite band?” in a pie chart, bar graph, table, or other appropriate graphic format. The survey, or the results of the survey, may also be published in newspapers, magazines, billboards, and other print media and any other suitable communication medium. The market research company may invite everyone who takes the survey, as well as anyone who views the survey or survey results, including the Internet user, to join the market research company survey panel, register to use or simply access the survey tool and run surveys of their own, and/or participate in the very survey whose results they're viewing. Viewers may also be asked to participate directly in other surveys sponsored by the market research company itself, or run by the market research company on behalf of a third party. Additionally, some third party surveys could be hosted on web servers of the third party. The link that the user clicks on in this case would take them to the web server of the third party. Thus, the market research company can market itself and its other customers, as well as add new members to its survey panel through various means, with very little effort and expense. The market research company is thus able to target those in online communities who are, or would likely be, interested in being survey takers and survey creators in order to promote participation in the market research company's survey panel and related services.

In another embodiment, the market research company may provide a downloadable software application for the survey tool either over the Internet or through a compact disc or other storage medium. The survey created by the Internet user may be hosted on the individual's own computer or server or that of a third party provider. In another embodiment a wireless application may be provided to allow the ordinary Internet user access to the survey tool via their mobile phone, PDA, or other wireless device in order to develop their own survey for posting on their website, blog, social networking or community site page, etc. The survey results and survey tool may be made accessible by any other means used to access the Internet.

### BRIEF DESCRIPTION OF THE SEVERAL VIEWS OF THE DRAWINGS

FIG. 1 shows a block flow diagram of an embodiment of a method for recruiting people to join an online survey panel.

FIG. 2 shows a schematic/block diagram of an embodiment of a system for recruiting people to join an online survey panel.

FIGS. 3-18 show representations of example screen shots of web pages that may be delivered by a server computer and displayed through a web browser on a display device of a client computer of a survey tool employed to recruit people to join an online survey panel.

FIG. 19 shows an example screen shot of a last page of a survey created with the survey tool that has an invitation to join an online survey panel.

FIG. 20 shows an example screen shot of a registration page of a market research company that allows a person to join an online survey panel.

FIG. 21 shows an example screen shot of a home page of a market research company that has a link to the registration page of FIG. 20 that allows a person to join an online survey panel.

FIG. 22 shows an example screen shot of a social networking site home page of a user who has created a survey and posted the results of one of the survey questions to the social networking site home page that has a link to the registration page of FIG. 20 that allows a person to join an online survey panel.

### DETAILED DESCRIPTION

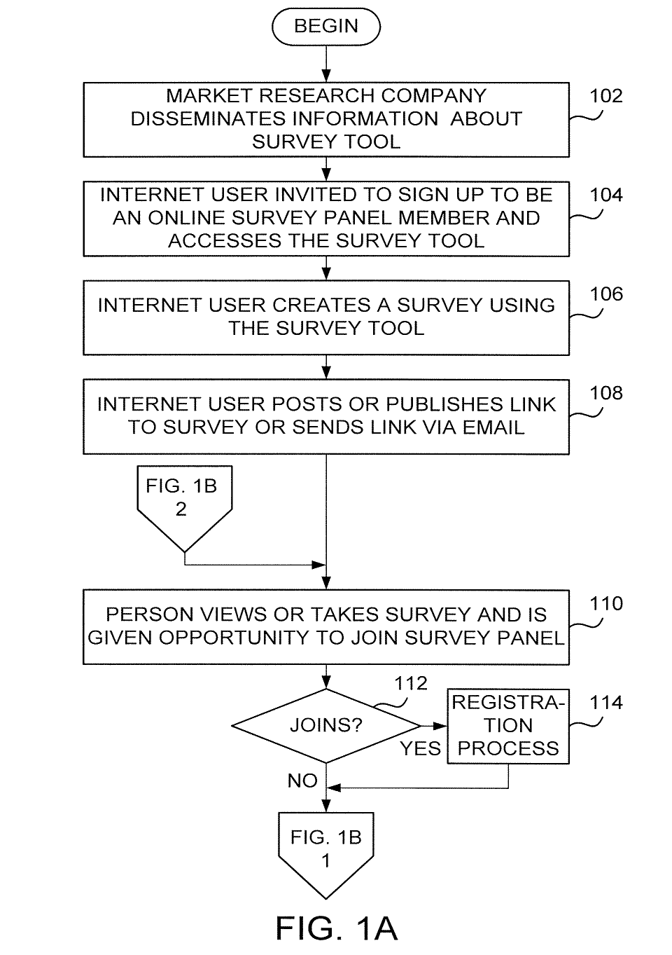

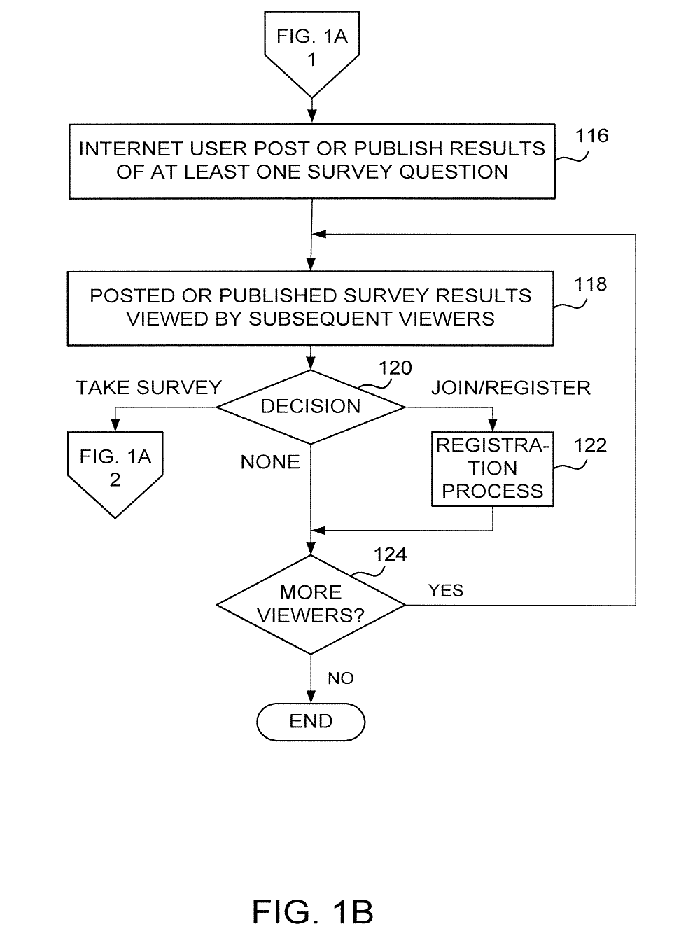

The invention may be implemented as a computer process, a computing system, or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process. Referring now to the Figures, in which like reference numerals and names refer to structurally and/or functionally similar elements thereof, FIG. 1 shows a block flow diagram of an embodiment of a method for recruiting people to join an online survey panel. Referring now to FIG. 1, in step 102 a market research company disseminates information offering a fun tool for survey making and survey taking that is available to those who are interested. The market research company may use various means to advertise the survey tool, including posting information on the market research company website, through promotional emails, or by placing paid advertisements on third party websites. The market research company may also publish information about the survey tool through direct mail pieces, ads placed in magazines or newspapers, press releases, or any other appropriate means. The survey tool may be made available free of charge, or alternatively for a fee, or made available upon one or more conditions (such as registration or joining an online survey panel), or access to the survey tool may be freely available to everyone, with no site registration required.

In step 104, online users who are interested in using the survey tool for their own particular purposes are invited to join the market research company sponsored online survey panel in exchange for access to the survey tool. In another embodiment, the online users are not required to join the market research company's online panel in order to gain access to the survey tool. However, by registering on the market research company's website and/or becoming a member of the company's online survey panel, the online users will receive announcements from time to time from the market research company about newly posted surveys. The online survey panel members may have the opportunity to earn or win cash prizes, gift certificates, or other types of awards and premiums offered for taking part in various surveys. Plus, the online survey panel members have the opportunity to voice their opinions on issues and topics that are important or interesting to them. Survey panel members have the freedom to participate on a survey-by-survey basis. In either embodiment, the Internet user then accesses the survey tool through a web server of the market research company, through a software download (via the Internet or a compact disc), through a wireless platform, or any other suitable method provided by the market research company.

In step 106 the Internet user creates their own survey. In one embodiment of the survey tool, the Internet user may be able to create a survey, quiz, test, poll, or other type of query tool. The market research company may impose some size and space requirements designed within the survey tool. The following is one embodiment of an implementation of the software tool, and should not be construed as limiting the many different ways in which the software tool could be designed. In the following example, there is a requirement of only two questions per page, and up to ten pages total. The survey tool provides the Internet user with space to write survey questions having up to 250 characters and spaces per question. The question/answer formats Internet users can choose from may include:

1. Question plus a response of “Yes,” “No,” and optionally “I don't know.”

Example:

Have you ever purchased a product or service from our website?

Yes

No

I don't know

2. Question plus single response rating scale question using radio buttons. The radio buttons could be horizontal or vertical, and the Internet user may choose the number of radio buttons up to 10. The Internet user may also dispense with numbers and create their own text scale (e.g., excellent, good, fair, or poor).

Example 1, rating scale type:

Which of the following categories best describes your last experience purchasing a product or service on our website? Would you say that your experience was:
Very pleasant
Somewhat pleasant
Neither pleasant nor unpleasant
Somewhat unpleasant
Very unpleasant

Example 2, rating scale type:

Would you say our web site is:
Very Attractive
9
8
7
6
5
4
3
2
1—Very Unattractive

For the previous two examples, only one radio button may be checked by the survey taker. Should the survey taker change his or her mind, the “check” would move from the originally checked radio button to the newly checked one.

3. Question plus multiple response check box question. The survey tool provides up to twelve categorical user-defined answers, each of which is no more than 40 characters in length. An option for “Other” with an open-end text field at the end may be used.

Example:

How have you heard about our web site? Please check all that apply.
Television
Radio
Newspaper
Magazine
Word-of-mouth
Internet
Other: Please Specify ______ (Optional open end text field)

The “Other” result may be presented in aggregate only. Access to the list of “Other” responses may not be coded and tabulated, or may be made available for download and tabulation. Survey takers may be required to answer all questions. At the end of the creation phase, the Internet user will have the ability to preview and make changes to the survey before it goes live. The market research company may limit each Internet user to having only a certain number of “live” surveys at any one time, and may allow archived copies of surveys to be kept. Surveys may be deleted by the Internet user, but if so, they typically will not be recoverable.

One skilled in the art will recognize that the above is only one example of the types of conditions, options, and constraints that may be built in to the survey tool. Various other types of designs of the survey tool may be employed within the scope of this disclosure. In addition to the survey example given above, the survey tool may also provide the Internet user with the ability to create tests, quizzes, and polls, or any other type of querying tool. Tests typically have right and wrong answers. Quizzes generally are designed to ask one or more questions that do not have right or wrong answers, but the answers provided to the questions will dictate one or more responses or results. For example, a quiz may ask ten questions related to how a person feels about his/her friendliness toward others. The result could be a score or other representation that ranks the individual on a scale based on numerical associations with his/her answers. A poll is a type of survey that is usually very short and often contains only one question, the purpose of which is to gage peoples' views on a particular topic (e.g., to determine the public's view on the president's foreign policy). Quizzes and tests also use questions and answers, but typically with a scoring system. A test, like in school, results in a score based on the number of right and wrong answers. In contrast, there are no right or wrong answers to the questions of a quiz. Instead, a numerical scoring system may be used to rank or otherwise evaluate a person against a set scale.

The survey tool allows the Internet user in step 108 to post a graphic image or text line with the URL link for the survey to their website, blog, social networking or community site page, or other Internet area, or even transmit the image or URL link via a cell phone, television, or any other suitable medium for others to view and access. The computer code for a graphic image or text line snippet is provided for in the survey tool. Alternatively, the Internet user may send an email to others with the URL link for the survey, which is hosted on the market research company web server. The graphic image or text line with the URL may also be published in a magazine, newspaper, billboard, etc., or some other form of medium.

In step 110, a person who views the Internet user's website, blog, social networking or community site page, magazine, newspaper, billboard, etc., or the person who views the email sent by the Internet user, may click on the link provided, or type in the link on a web browser, which will take the person to the survey page hosted on the market research company web server or hosted on the Internet user's own computer or web server. The person then has the opportunity to view the survey results and take the survey. Various messages are built into the end of the survey by the survey tool, such as an invitation to join the market research company survey panel, to participate in the survey whose results they're viewing, to participate in a third party survey being hosted by the market research company, or to become a survey creator and access the survey tool that will enable them to create their own surveys. Additionally, when the Internet user posts the results of their survey on their Internet page, or publishes the results of their survey in print media or some other medium, viewers can merely view the results (and take no further steps), they can click on a link (text or graphic) or type in the link in a web browser that will take them to a page where they can join the market research company's survey panel, or they can click on a link (text or graphic) or type in the link in a web browser that will take them to a page where they can take the survey whose results they're viewing and weigh in with their own opinions. Alternately, viewers could take a third party survey being hosted by the market research company or hosted by the third party, as well as choose to register (required or not) on the market research company's website to access the survey tool or register to become a member of the market research company's online survey panel.

Also, creators of surveys may create and run surveys for which they have no intention of publicly posting or publishing the results for others to view. For example, surveys designed to help make decisions related to marketing products, improving employee or customer satisfaction, testing the feasibility of a new product, etc., are typically not publicly posted or published for review.

At the end of the survey the survey taker may also be presented by the market research company with a particular incentive to join the survey panel, including a marketing message explaining how the survey taker can take fun surveys from time-to-time and receive the particular incentive currently being offered. These incentives can be changed from time-to-time by the market research company. After completing the survey, a thank you web page is displayed on the viewer's web browser that may bear yet another invitation for the survey taker to join the market research company survey panel.

If the survey taker in step 112 decides to join the survey panel, then by clicking on a link on the survey page, the survey taker is taken to a new web page for the registration process in step 114. The survey taker fills in information required to join, which may include: email address, first name, last name, gender, date of birth, country, and ethnic background. Additional optional information, which the survey taker may or may not choose to disclose, may also be requested. At the end of the registration process, the survey taker may be informed that an email will be sent to confirm that the survey taker is the actual person who filled-in the information to join the survey panel. This step is designed to prevent someone from falsely signing up people to join who in fact are not interested and did not fill out the registration information.

Referring now to FIG. 1B, after returning from the registration process of step 114, or if the survey taker in step 112 decided not to join the survey panel, in step 116 the market research company web server posts the results of at least one survey question selected by the Internet user during the creation of the survey to the Internet user's website, blog, social networking or community site page, other Internet area, cell phone, television, etc., and saved at the Internet user's designer page maintained on the market research company web server or on the Internet user's own computer or server, or the Internet user publishes the results in a magazine, newspaper, billboard, or other medium. In another embodiment, no survey results are posted to the Internet user's website, blog, social networking or community site page, etc. When results are posted, the Internet user chooses the size of the image to be presented on their website, blog, social networking or community site page, etc., during the survey creation process. The survey results may be posted in a number of different ways, including textually, audibly, or in a graphic way, which enhances the visual appearance or audio quality of the Internet user's website, blog, or social networking or community site page, print media, or other medium, etc. The graphic posting may be in the form of a pie chart, vertical or horizontal bar graph, descending or natural scale table of percentages, or any other appropriate visual or audio form supported by the survey tool. Part of the graphic image may include a link to the market research company website. Also, the graphic image may include an invitation to join the survey panel, and may include the link that will take a viewer to the market research company's registration web page. There may also be a link under the image that may say “See All Results,” which will take the survey taker back to the market research company website to see all of the results of the survey, which may show one result per page, up to ten pages. The survey results page may include an invitation to join the survey panel, an invitation to take other surveys sponsored by the market research company (its own or on behalf of third parties), and an invitation to take surveys that are hosted by third parties. The survey results posted non-electronically could show a date-specific sample, and results posted electronically may show a running “real-time” sample size. While some survey results may be updated in real-time, typically cached images are used that are updated on a scheduled basis, typically every five or ten minutes, although the update interval could be longer.

In step 118 a viewer of the Internet user's website, blog, social networking or community site page, cell phone, television, print media, or other medium may view the graphic results of one or more of the survey questions, the link to take the survey they are viewing or other surveys, the link to register (required or not) to access the survey tool to create their own surveys, as well as the link to the invitation to join the survey panel. In decision step 120, the viewer may decide to use the survey tool or to join the survey panel by clicking on, or typing in, the link provided, decide to take the one or more surveys by clicking on, or typing in, the link provided, or do nothing. If the viewer decides to take one or more surveys, control flows back to step 110 and the steps following may be repeated. If the viewer decides to use the survey tool or decides to join the survey panel, then in step 122 the viewer is taken through the registration process as described in step 114. In step 124, if there are more viewers, then the above steps beginning with step 118 may be repeated over and over again as different viewers may become survey takers or viewers of the posted or published survey results. If not, then the method ends. One skilled in the art will recognize that many variations in the above steps may be implemented that are within the scope of this disclosure, and as defined by the appended claims. The method described above is but one of many implementations and should not be construed to be limiting to the scope of the appended claims.

In another embodiment, online users may use the survey tool at no cost to themselves, but in exchange for use of the tool, one or more banner ads will also appear on the web pages associated with taking the survey and viewing the posted survey results. Each survey taker and survey results viewer will be asked at various points to join the survey panel as described above, and will be invited to create their own surveys by registering (required or not) online with the market research company to become eligible to use the survey tool. Online users may also choose to receive daily or weekly emails from the market research company with basic statistics on active surveys, which would encourage the online users to return to the market research company website to view more detailed statistics.

As a result of the above described method, the people who use the survey tool may be invited to join the survey panel, and the people who complete surveys and the people who view survey results may also be asked to join the survey panel. The method thus takes advantage of an activity that many people enjoy doing-taking surveys of interest and viewing the results—to promote joining the online survey panel, as well as creating their own surveys, taking more surveys, and viewing the results. Thus, the people who create their own surveys, the people who take the surveys, and the people who view the survey results are all candidates for joining the market research company online survey panel and/or the group of survey creators who, in turn, promote all of the activities described herein. This method builds up the market research company online survey panel at very little cost, as the development costs for the survey tool are spread out over all of the candidates who join the online survey panel over time.

This method helps to build a community around the survey takers. By allowing people to post their survey results on their website, blog, social networking or community site page, cell phone, television, or published in print media, or some other medium, their surveys and survey results are going to stir people up and make them in turn want to provide their comments and feedback, and to tell their side of the story through message boards and other ways of interacting with one another. The survey community will be a vibrant community who concur with or refute results, and may even create their own surveys to show a different point of view. The method thus has a viral component to it. The benefit to the market research company is that there are few costs associated with the online users and viewers that join the online survey panel. Among other things, the method taps into any website, including but not limited to, social networking or community sites, and many others in a way that takes advantage of the fact that millions of people have pages on these social networking websites. Young people especially like to take surveys, and tapping into these social networking sites will generate a large number of page views on the market research company website, thereby increasing the revenue stream from the placement of banner ads. The method thus takes advantage of the very thing that many people are going to be doing and which they like to do. As new online survey panel members join and contact their friends and acquaintances within their online social network, they essentially are promoting the market research company, resulting in even more new online survey members.

Though the discussion of the method above has been in reference to a market research company, one skilled in the art will recognize that the various acts described may be performed by any type of company or by an individual. Or, the various acts described above may be performed in a distributed fashion by a company working in conjunction with one or more agents for the company, or by an individual working in conjunction with one or more agents for the individual. In addition, the various acts described above may be performed in a distributed fashion by two or more parties (companies or individuals) acting together jointly as a partnership, with or without the help of one or more agents working in conjunction therewith.

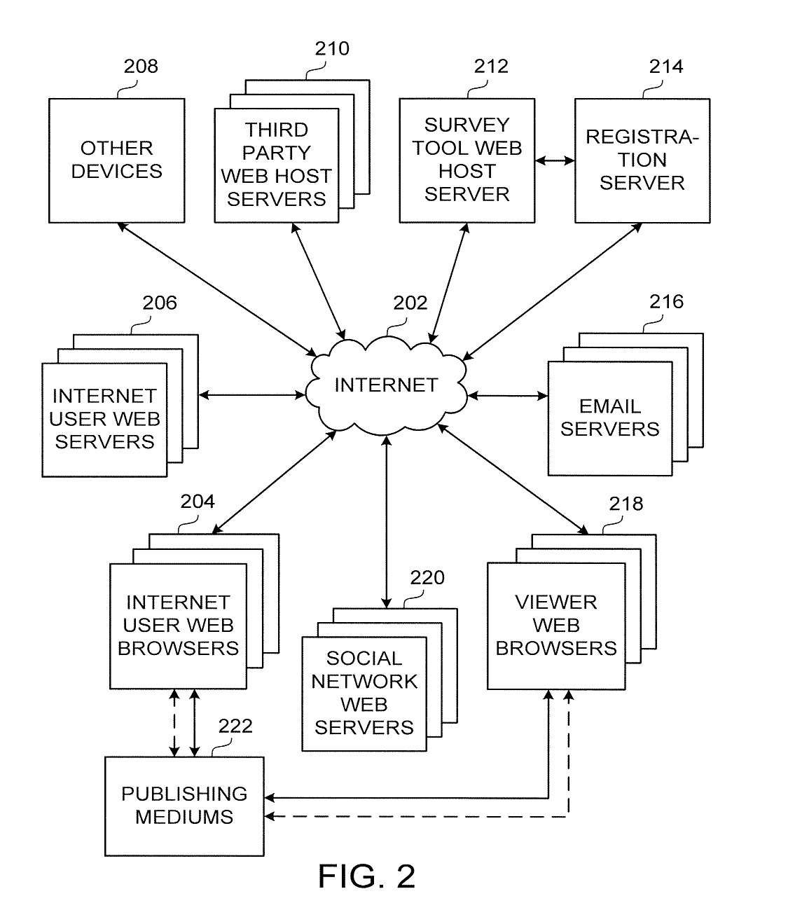

FIG. 2 shows a schematic/block diagram of an embodiment of a system for recruiting people to join an online survey panel. Referring now to FIG. 2, the solid line double arrows represent communications links between various devices, and may include wire, wireless, optical, infrared, and other commonly utilized electronic communications channels, singly or in combination with each other. The dashed line double arrows represent non-electronic links. Utilizing Internet User Web Browsers 204 and the Internet 202, an Internet user accesses the web page of a market research company to learn about a fun tool for survey making and survey taking that is available to those who are interested, provided that the Internet user joins the market research company online survey panel. Alternatively, the Internet user may learn about the survey tool from information published virtually anywhere, including on TV, on cell phones, PDA's or other electronic devices or in non-electronic media, such as magazines, newspapers, billboards, and other mediums represented by Publishing Mediums 222. After joining the online survey panel, or after having been given the option to join the survey panel, the Internet user may be allowed to register to access the survey tool in any of the various means describe above. Again, users of the survey tool may not be required to register. In one embodiment, before access is allowed, the Internet user's email address is validated against a list kept in a database maintained by the market research company of valid online survey panel members. The survey tool is a turnkey tool that provides the Internet user with everything they need for creating, building, launching, managing, and posting results of the survey.

After creating their survey, the Internet user posts via the Internet 202 a graphic image or text line with the URL link for the survey to their website, blog, etc., hosted by Internet User Web Servers 206, or to their social networking or community site page hosted by Social Network Web Servers 220. Or, the Internet user may publish results electronically via TV, on cell phones, PDA's or other electronic devices or non-electronically via magazines, newspapers, billboards, and other mediums through Publishing Mediums 222. The survey tool provides the computer code for a dynamic graphic image or text line snippet. Alternatively, the Internet user may send an email to their friends via the Internet 202 and their Email Servers 216 with the URL link for the survey. The survey is hosted on the market research company Survey Tool Web Host Server 212 and is accessed via the URL link.

A viewer, utilizing Viewer Web Browsers 218, may view the Internet user's website, blog, social networking or community site page, etc., the email sent by the Internet user, or through various electronic or non-electronic Publishing Mediums 222. The viewer may click on, or type in, the link provided to take the viewer to the survey page hosted on the market is research company Survey Tool Web Host Server 212. The viewer then has the opportunity to take the survey, which is conducted on Survey Tool Web Host Server 212. At the end of the survey, the survey tool automatically includes an invitation to the survey taker to join the market research company's online survey panel, an invitation to become a survey creator, and/or an invitation to join the survey panel of a third party market research entity. The market research company may partner with other research companies by offering, typically for a fee, to “populate” their surveys with survey participants through this same mechanism.

If the survey taker decides to join the survey panel, then clicking on a link on the survey page will take the survey taker to a new web page for the registration process hosted by the market research company Registration Server 214. The survey taker fills in the required information and then submits it to join the online survey panel.

After the survey taker takes the survey, Survey Tool Web Host Server 212 may post the results of at least one survey question, selected by the Internet user during the creation of the survey, to the Internet user's website, blog, etc., via Internet User Web Servers 206, or the Internet user's social networking or community site page via Social Network Web Servers 220, or published electronically or non-electronically through Publishing Mediums 222. Survey results are kept in detail on Survey Tool Web Host Server 212 and saved at the Internet user's creator page maintained on Survey Tool Web Host Server 212.

A viewer utilizing Viewer Web Browsers 218 may view the Internet user's website, blog, social networking or community site page, etc., and see the graphic image posted by Survey Tool Web Host Server 212 of the results of the one or more survey questions, and also a link to take the survey themselves or take a different survey hosted by the market research company or hosted by a third party, a link to access the survey tool, and also a link to an invitation to join the online survey panel. If the viewer decides to access the survey tool to create their own surveys or join the online survey panel, the viewer clicks on, or types in, the link provided, and is taken to the registration web page hosted by Registration Server 214. If the viewer decides to take the survey, the viewer clicks on, or types in, the link provided, and is taken to the survey page hosted by Survey Tool Web Host Server 212 or Third Party Web Host Servers 210. In addition, cell phones, personal digital assistants, iPods, televisions, or any other type of computing device represented by Other Devices 208 may be utilized to access the survey tool via the Internet 202 and Survey Tool Web Host Server 212.

One skilled in the art will recognize that many other variations in the system described above may be implemented that are within the scope of this disclosure, and as defined by the appended claims. The system described above is but one of many implementations and should not be construed to be limiting to the scope of the appended claims.

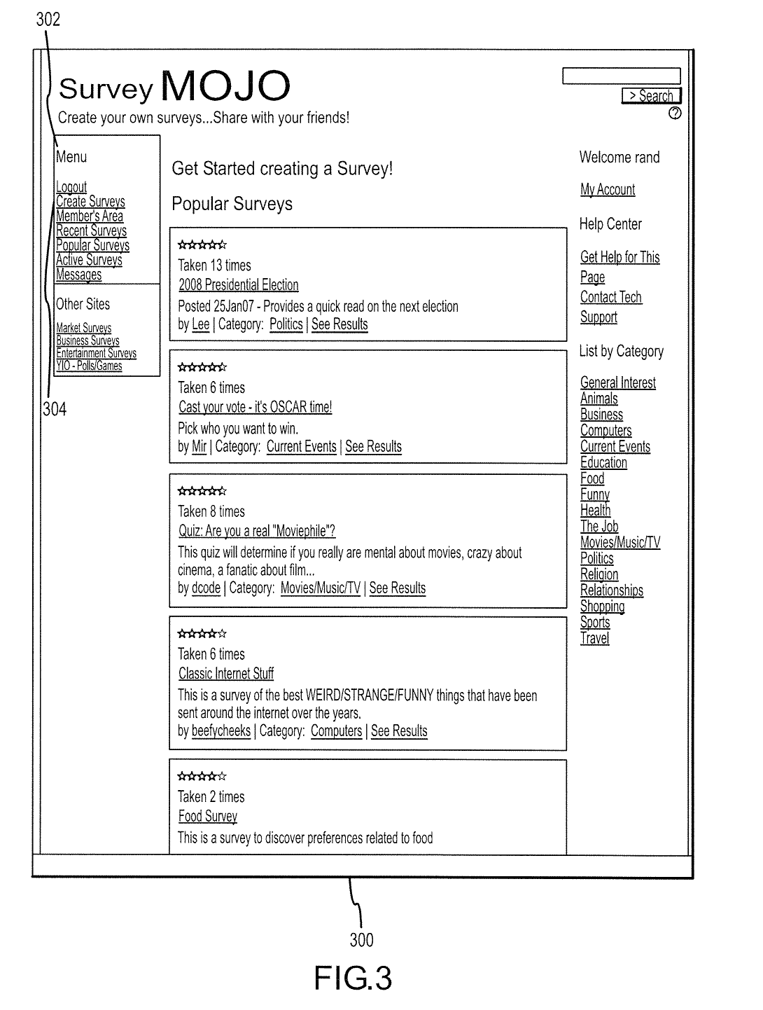

FIGS. 3-18 show one example embodiment of representations of screen shots of web pages of a web-based application for a survey tool delivered by a server computer that may be displayed through a Web browser on a display device of a client computer. Referring now to FIGS. 3-18, in FIG. 3 Home Page 300 of a web-based application for a survey tool is shown. Menu 302 provides links to various features of the web site hosted by the market research company and to the survey tool.

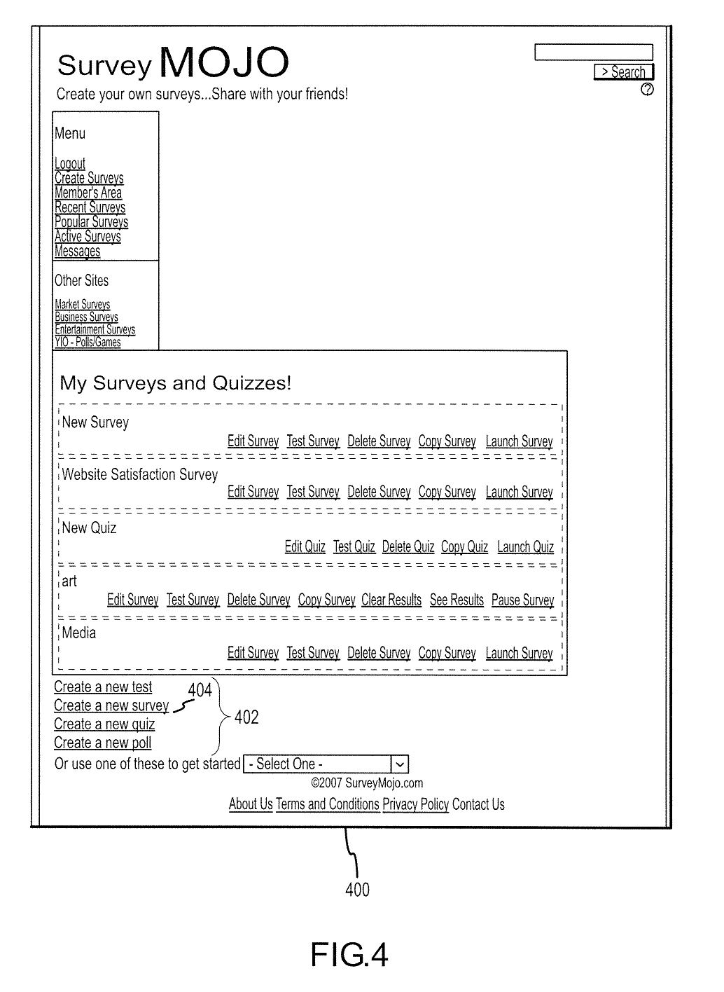

Clicking on Create Surveys Link 304 will return My Surveys Page 400 to the user's web browser as shown in FIG. 4. The survey tool allows the user to create a number of different query types. By clicking on one of the Create Links 402, the survey tool will allow the user to create the type of query identified, which in this embodiment includes tests, surveys, quizzes, and polls.

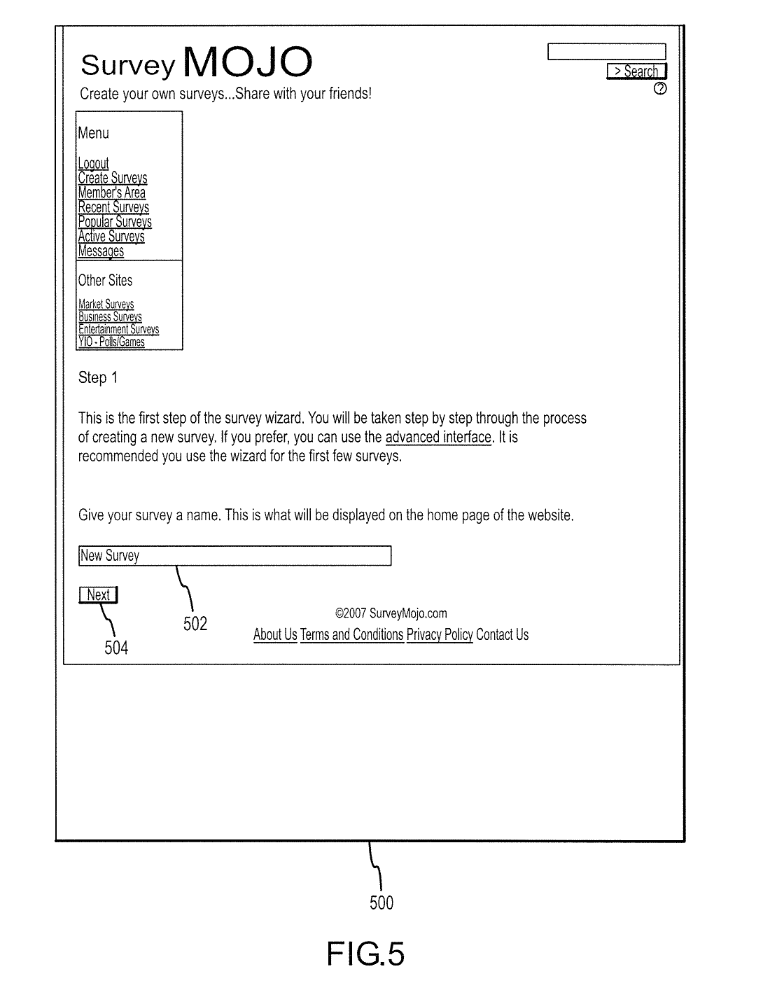

In this example, the user has clicked on Create A New Survey Link 404, which will return Step 1 Page 500 to the user's web browser as shown in FIG. 5. Step 1 Page 500 and the next several following pages comprise a survey wizard designed to make it easy for a first time user to create their first few surveys. Once familiar with the process, the Internet user may skip the wizard and just use the regular user interface for the survey tool. The onscreen instructions invite the user to type in a name for the survey being created in Text Entry Box 502.

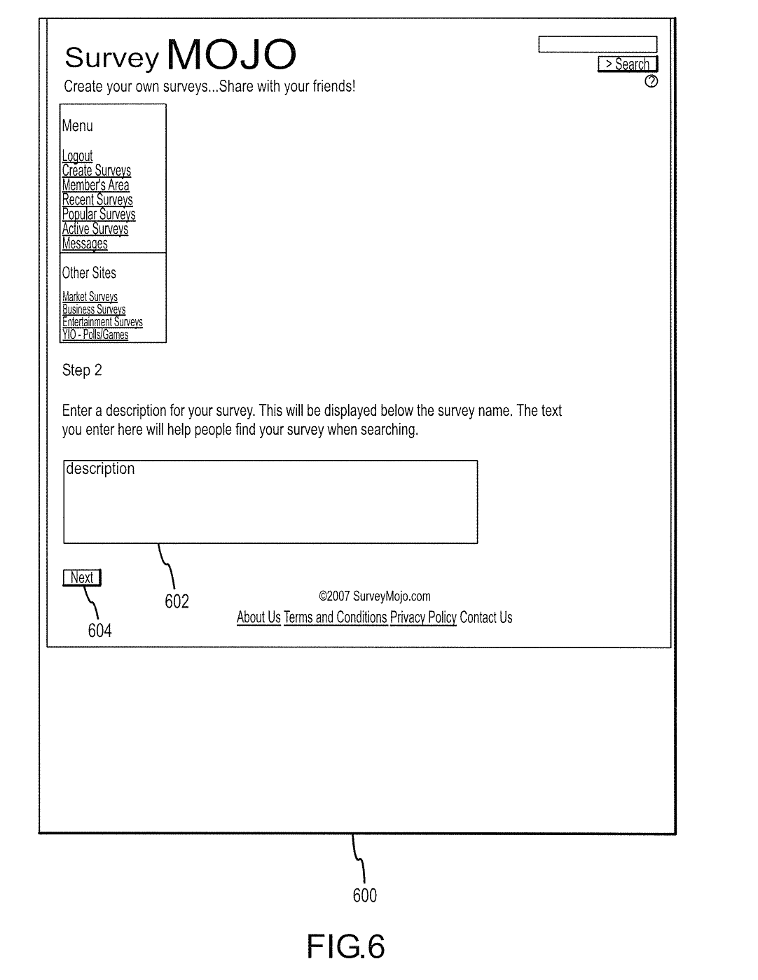

Clicking on Next Button 504 will return Step 2 Page 600 to the user's web browser as shown in FIG. 6. The onscreen instructions invite the user to type in a description of the survey to be created in Text Entry Box 602.

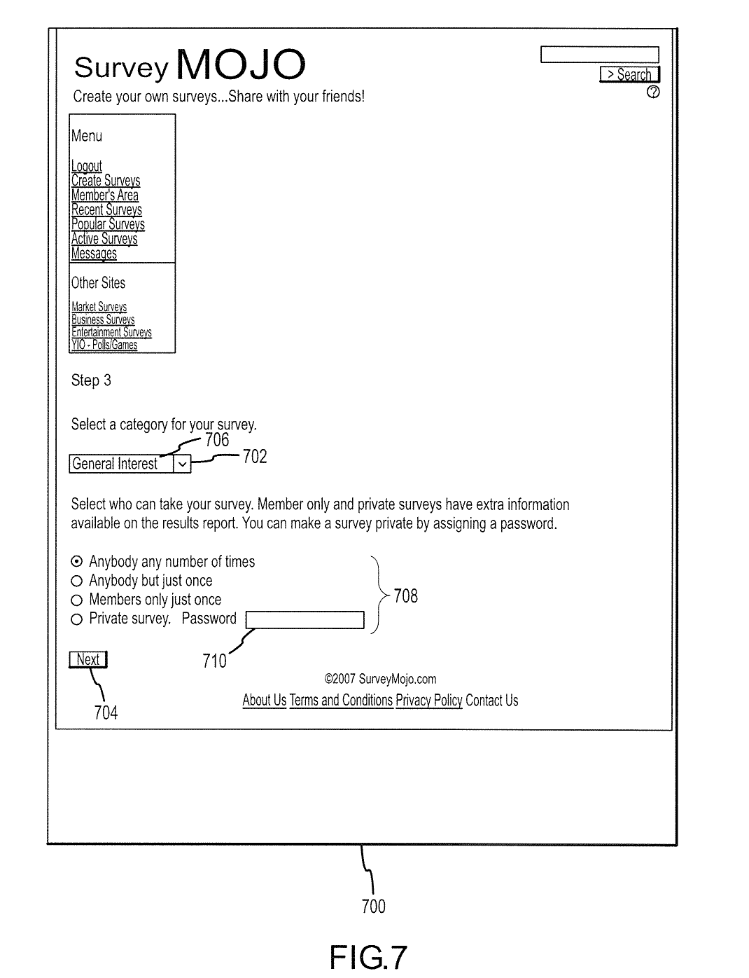

Clicking on Next Button 604 will return Step 3 Page 700 to the user's web browser as shown in FIG. 7. The onscreen instructions invite the user to select a category for the survey to be created. Clicking on Down Arrow 702 will reveal the contents of Pull Down Menu 706, which presents a predefined list of categories that the user may choose from. Once the user makes a choice by clicking on an item in the list, the list collapses and the choice is revealed in Pull Down Menu 706. The onscreen instructions also invite the user to select who he will permit to take the survey. A predefined list of who may take the survey is displayed on screen, and the user may make a choice by clicking within one of the Radio Buttons 708 displayed in front of each choice. The radio button clicked on will become solidly filled-in, indicating the user's choice. In this example, one of the options the user may select is for a private survey. For such a private survey, the user has to create a password, which is entered in Password Entry Box 710.

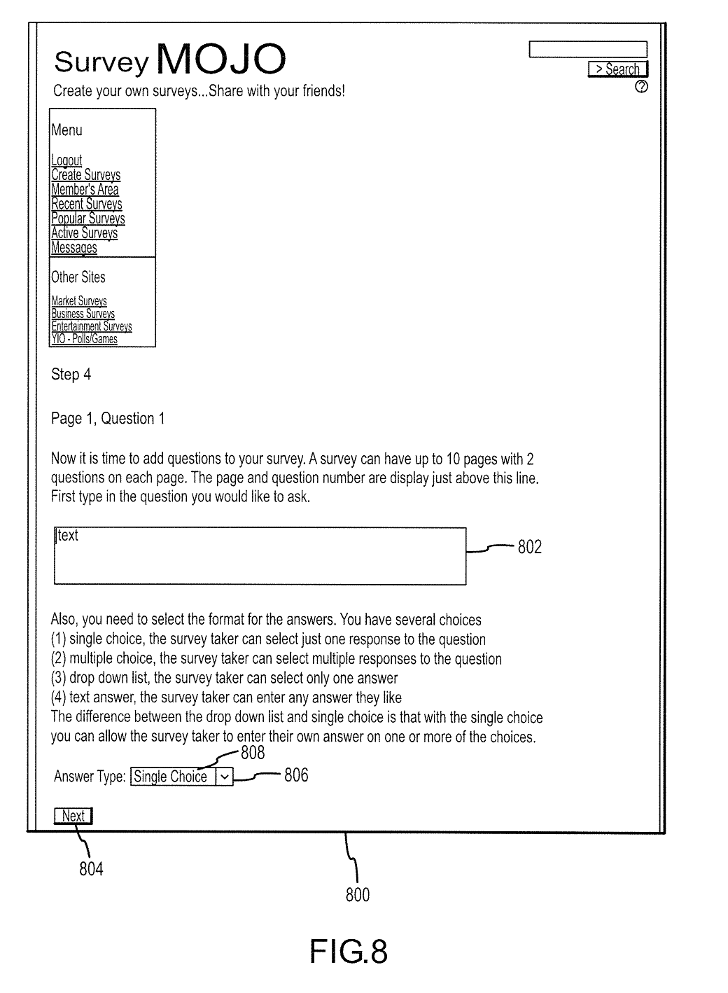

Clicking on Next Button 704 will return Step 4 Page 800 to the user's web browser as shown in FIG. 8. The onscreen instructions invite the user to begin creating questions for the survey. The constraints that apply to this step are shown on screen. The user may type in the first question of the survey in Text Entry Box 802. The choices that the user has for the format for the answer for this question are shown on screen. Clicking on Down Arrow 806 will reveal the contents of Pull Down Menu 808, which presents a predefined list of answer formats that the user may choose from. Once the user makes a choice by clicking on an item in the list, the list collapses and the choice for the answer type is revealed in Pull Down Menu 808.

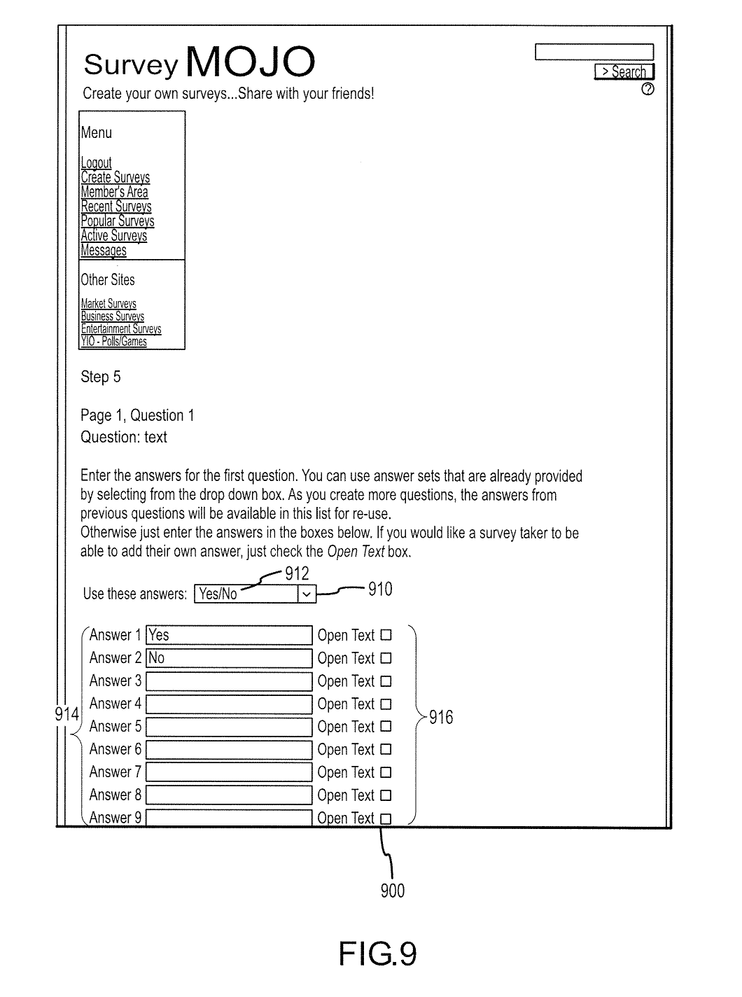

Clicking on Next Button 804 will return Step 5 Page 900 to the user's web browser as shown in FIG. 9. The onscreen instructions invite the user to enter the answers for the first question. Clicking on Down Arrow 910 will reveal the contents of Pull Down Menu 912, which presents a predefined list of answer sets that the user may choose from. Once the user makes a choice by clicking on an item in the list, the list collapses and the choice is revealed in Pull Down Menu 912, and the corresponding set of answers are displayed in Answer Boxes 914. To enable a survey taker to add their own answer, the user can click on an Open Text Box 916.

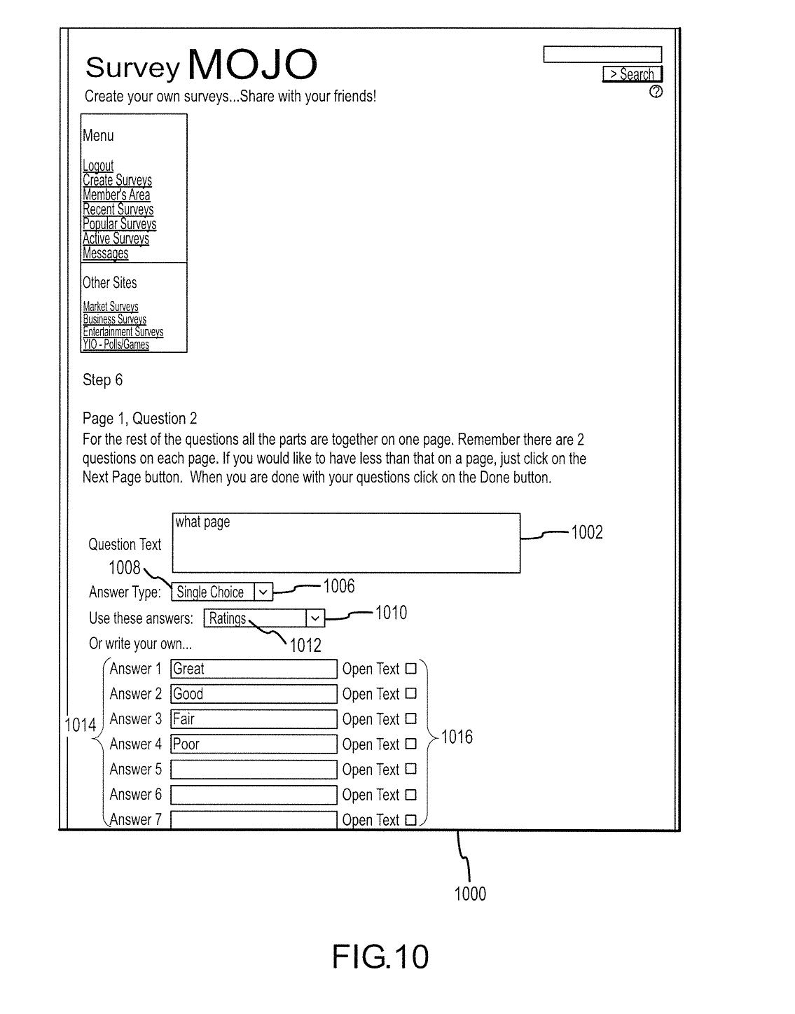

Clicking on a Next Button (not visible in FIG. 9) will return Step 6 Page 1000 to the user's web browser as shown in FIG. 10. The onscreen instructions indicate to the user that for the rest of the questions all of the parts for a question are together on the displayed web page. For the second question, the user types in the question for the survey in Text Entry Box 1002. Clicking on Down Arrow 1006 will reveal the contents of Pull Down Menu 1008, which presents the predefined list of answer formats that the user may choose from. Once the user makes a choice by clicking on an item in the list, the list collapses and the choice is revealed in Pull Down Menu 1008. Clicking on Down Arrow 1010 will reveal the contents of Pull Down Menu 1012, which presents the predefined list of answer sets that the user may choose from. Once the user makes a choice by clicking on an item in the list, the list collapses and the choice is revealed in Pull Down Menu 1012, and the corresponding set of answers are displayed in Answer Boxes 1014. To enable a survey taker to add an original answer, the user can click on an Open Text Box 1016. Clicking on a Next Button (not visible in FIG. 10) will return a Next Question Page (not shown) allowing the user to add the next question to the survey. The user can continue to click on a Next Button on the currently displayed page to add more questions until the maximum number of questions allowed is reached. If there are no more questions to add to the survey, the user clicks on a Done Button on the currently displayed page (not shown).

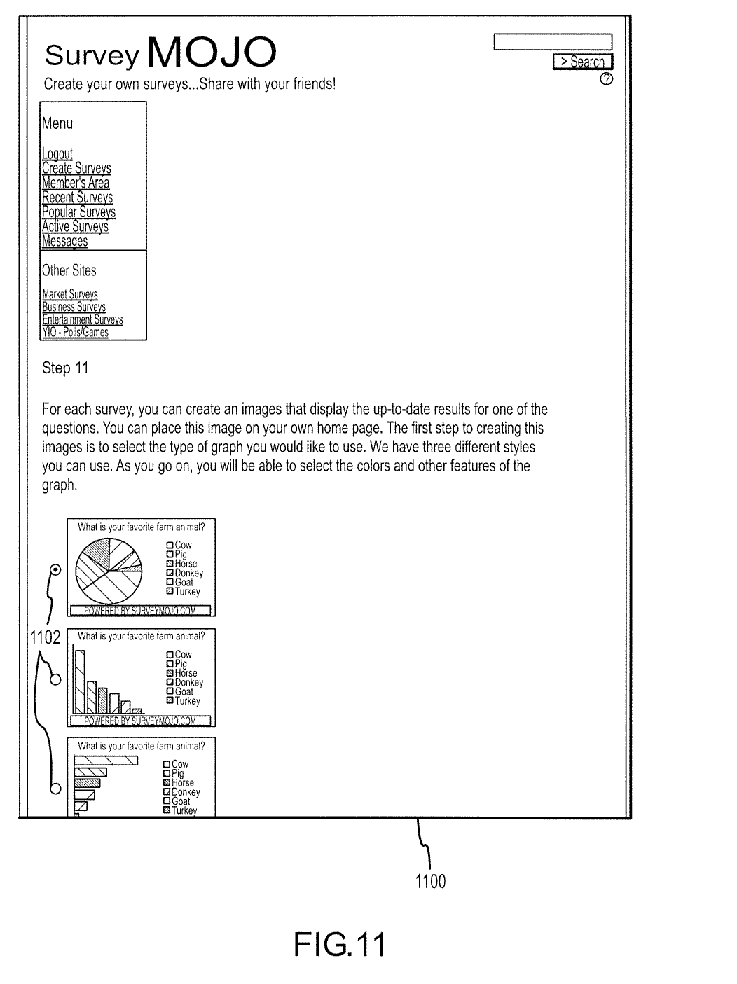

Clicking on a Done Button will return Step 11 Page 1100 to the user's web browser as shown in FIG. 11. The onscreen instructions indicate to the user that a graphic image can be created that displays the up-to-date results for one of the survey questions. In another embodiment, a graphic image showing results for each question in the survey may be created. In this example, there are three graph styles to choose from: pie chart, vertical bar graph, and horizontal bar graph. The user may select a style by clicking within one of the Radio Buttons 1102 displayed in front of each choice. The radio button clicked on will become solidly filled-in, indicating the user's choice. In this example, the pie chart graph style has been selected.

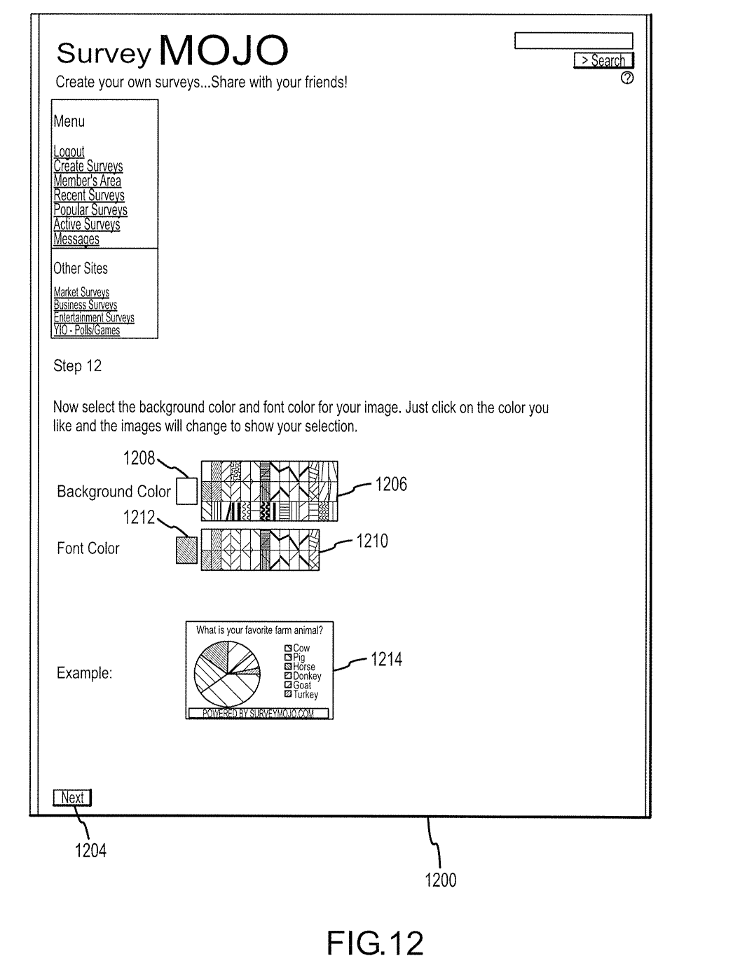

Clicking on a Next Button (not visible in FIG. 11) will return Step 12 Page 1200 to the user's web browser as shown in FIG. 12. The onscreen instructions indicate that the user may now select a background color and a font color for the graphic image. The user may select a background color by clicking on one of the colors displayed in Background Color Selection Box 1206. The color selected is then displayed in Background Color Box 1208. The user may also select a font color by clicking on one of the colors displayed in Font Color Selection Box 1210. The color selected is then displayed in Font Color Box 1212. As color selections are made or changed, the results are displayed in Example Box 1214. In this example, the background color is white and the font color is black.

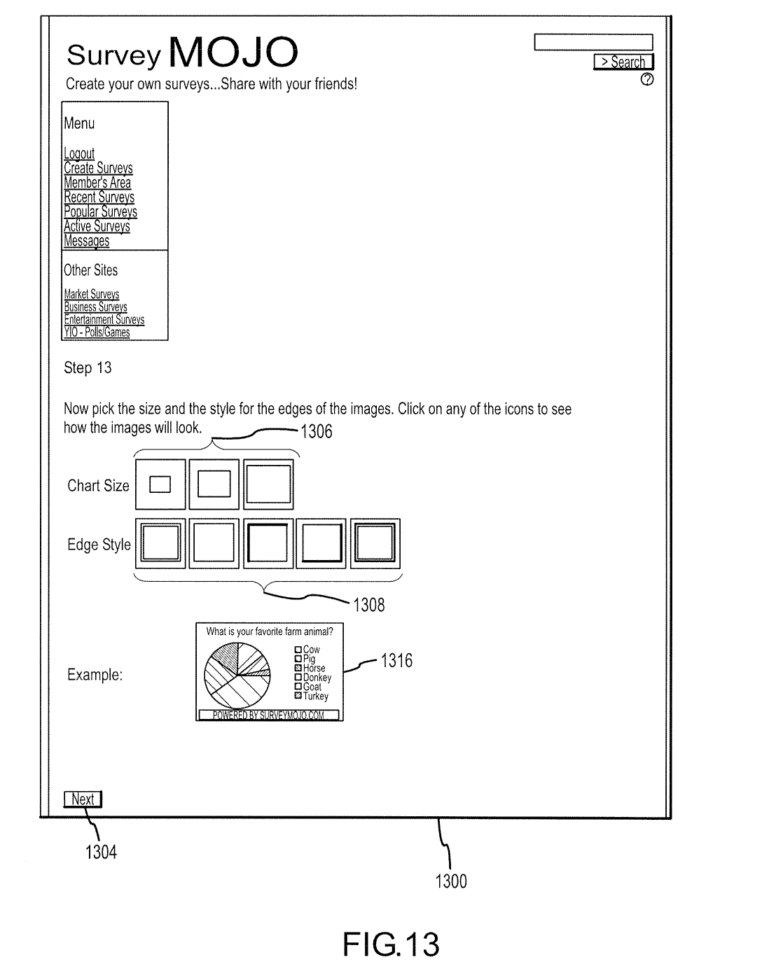

Clicking on Next Button 1204 will return Step 13 Page 1300 to the user's web browser as shown in FIG. 13. The onscreen instructions indicate that the user may now select the size of the image and the edge style for the image. The user may select the size of the image by clicking on one of the Chart Size Boxes 1306. The user may select the edge style for the image by clicking on one of the Edge Style Boxes 1308. As size and edge style selections are made or changed, the results are displayed in Example Box 1316.

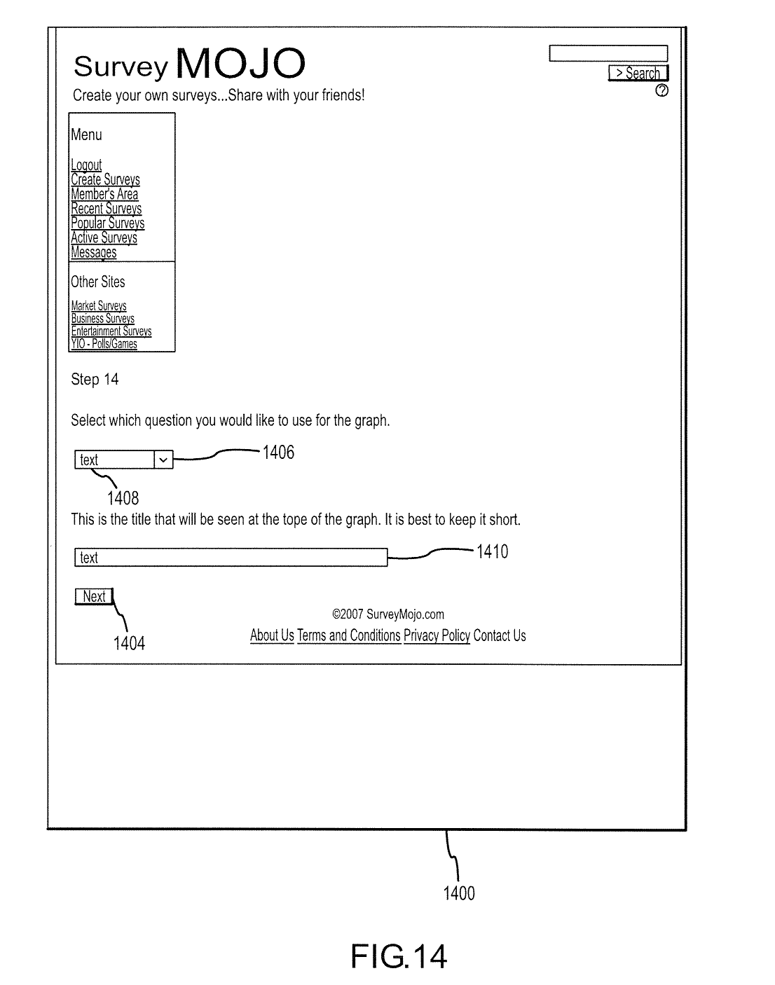

Clicking on Next Button 1304 will return Step 14 Page 1400 to the user's web browser as shown in FIG. 14. The onscreen instructions indicate that the user may now select which question in the survey to use for the graphic image. Clicking on Down Arrow 1406 will reveal the contents of Pull Down Menu 1408, which presents the list of questions in the survey that the user may choose from. Once the user makes a choice by clicking on a question in the list, the list collapses and the choice is revealed in Pull Down Menu 1408. In Text Entry Box 1410 the user can type in a title for the graph, which may be the text of the question selected or a shortened version of the question, or any other text desired by the user.

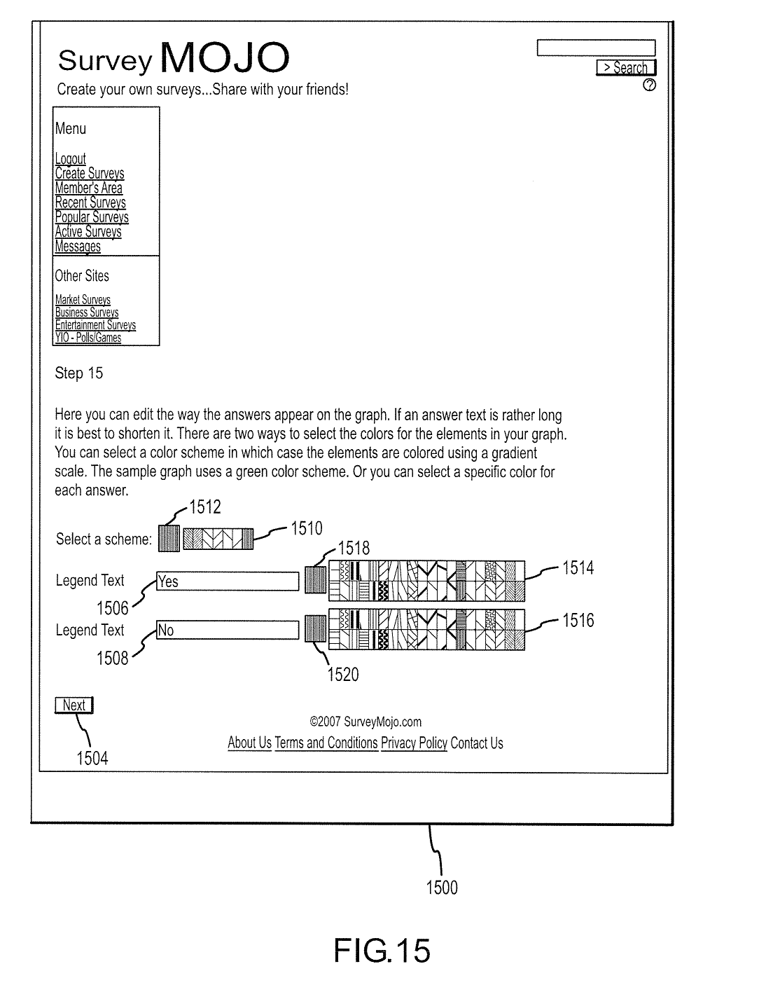

Clicking on Next Button 1404 will return Step 15 Page 1500 to the user's web browser as shown in FIG. 15. The onscreen instructions indicate that the user may now edit the way answers appear on the graph. In this example, the question selected has only two answers, Yes and No, which appear in Legend Text Boxes 1506 and 1508 respectively. If the answers are long, the user can click on the text within Legend Text Boxes 1506 and 1508 and edit the text to make it shorter. Since in this example the answers are short, no editing would be necessary, though the user could edit “Yes” to simply “Y” and “No” to simply “N.”

The onscreen instructions also indicate that the user may select a color scheme for the graph, and colors for the legend text. For example, the sample graph shown in FIGS. 11, 12, and 13 uses a color scheme, where each of the sections of the pie chart, or each of the bars in the horizontal and vertical bar graphs, will be a different shade of the color selected. The user may select a color scheme by clicking on one of the colors displayed in Scheme Color Selection Box 1510. The color selected is then displayed in Scheme Color Box 1512. In a similar fashion, the user may select the color of the legend text for the first and second answers by clicking on one of the colors displayed in Legend Color Selection Boxes 1514 and 1516. The color selected is then displayed in Legend Color Boxes 1518 and 1520.

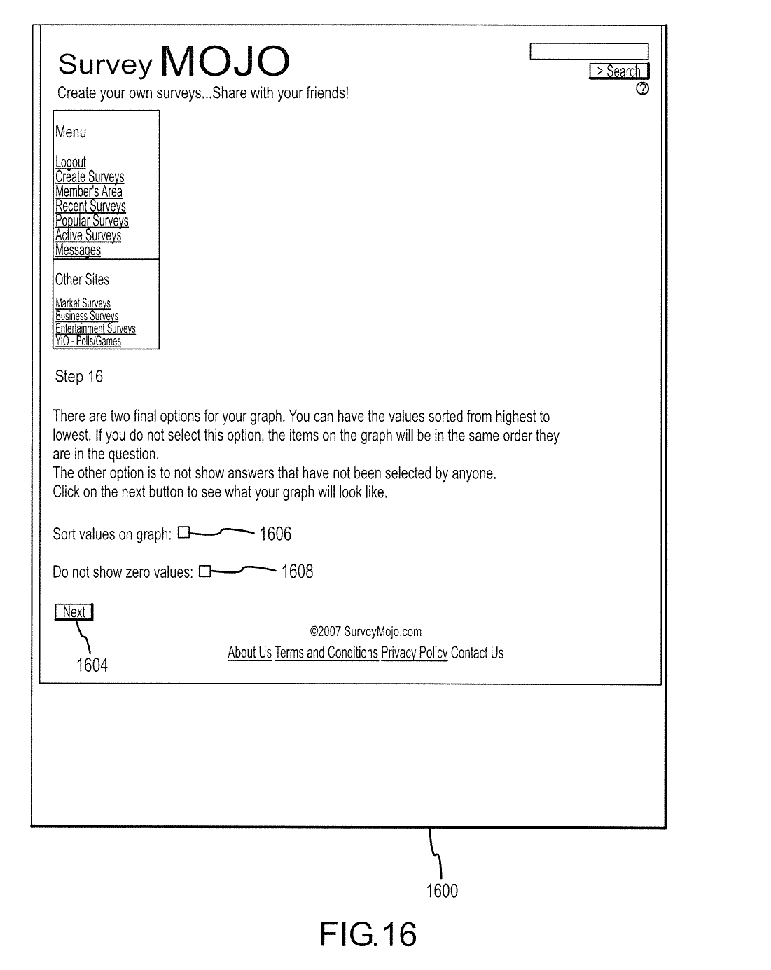

Clicking on Next Button 1504 will return Step 16 Page 1600 to the user's web browser as shown in FIG. 16. The onscreen instructions indicate that the user may choose to have the values for the graphic image sorted from highest to lowest by clicking in Check Box 1606. Otherwise, the items in the graph will appear in the same order they are in the question. Also, the user may choose to not show answers that have not been selected by any survey taker by clicking in Check Box 1608.

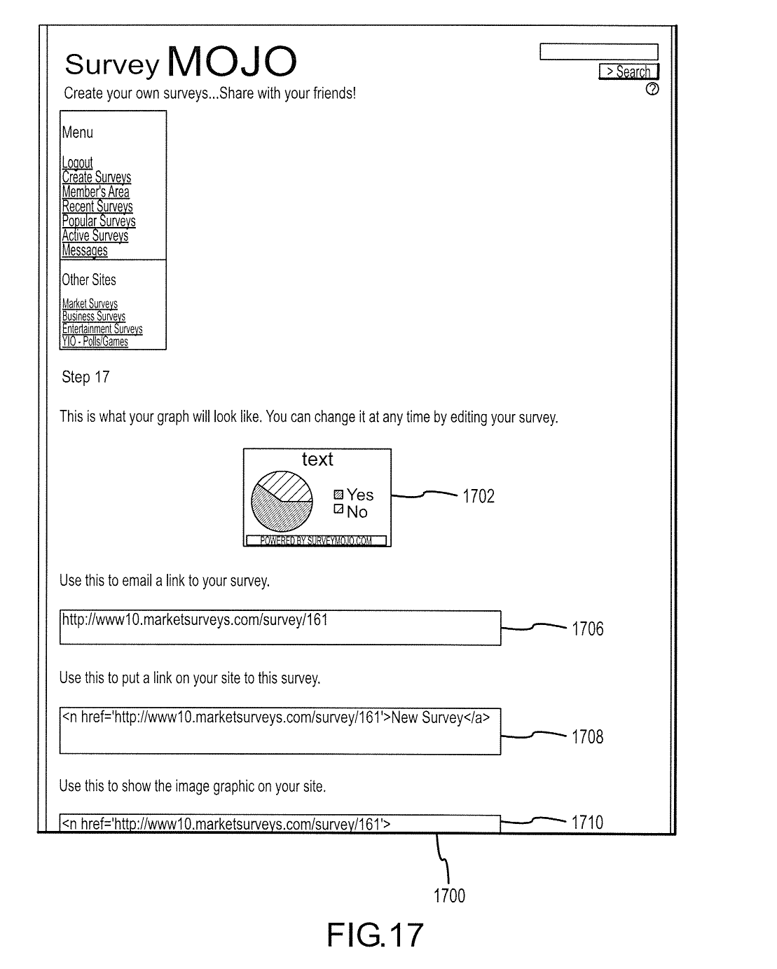

Clicking on Next Button 1604 will return Step 17 Page 1700 to the user's web browser as shown in FIG. 17. Example Box 1702 shows the user what the graphic image will look like. If the user has decided to distribute the survey through email, the user can copy the URL link shown in URL Link Box 1706 and include the link in an email. The URL link is automatically generated by the survey tool. In order to place a link to the survey on the user's website, blog, social networking or community site page, etc., the user can copy the HTML tag shown in Web Page Link Box 1708. In order to have the graphic image appear on the user's website, blog, social networking or community site page, etc., the user can copy the HTML tag shown in Graphic Image Link Box 1710. The HTML tags in Web Page Link Box 1708 and Graphic Image Link Box 1710 are automatically generated by the survey tool.

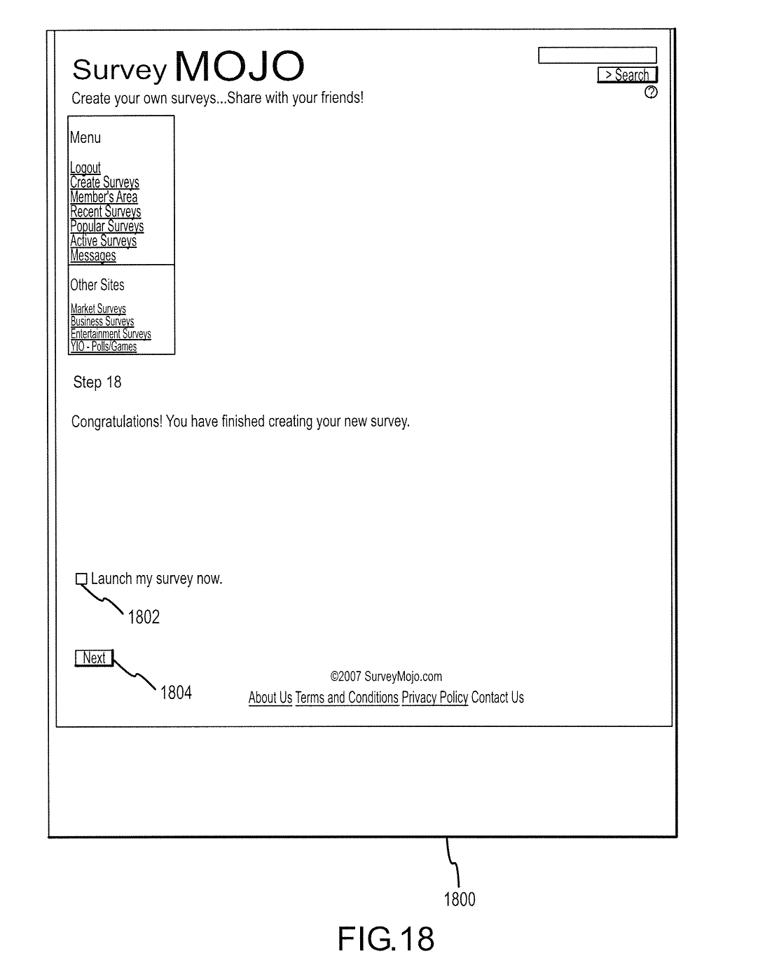

Clicking on a Next Button (not visible in FIG. 17) will return Step 18 Page 1800 to the user's web browser as shown in FIG. 18. From this page, the user can launch their survey by clicking on Check Box 1802 and then clicking on Next Button 1804. This activates the survey on the market research company's web host server so that the when a viewer of the user's website, blog, social networking or community site page, etc., clicks on the link placed by the user from Web Page Link Box 1708, or when a recipient of the user's email clicks on the link in the email from URL Link Box 1706, the viewer or recipient is taken to the web page hosted on the market research company's web host server where they can take the survey. The next page in the wizard (not shown) provides a summary of all of the surveys the user has created, indicates which are live, and allows the user access to edit the surveys, etc.

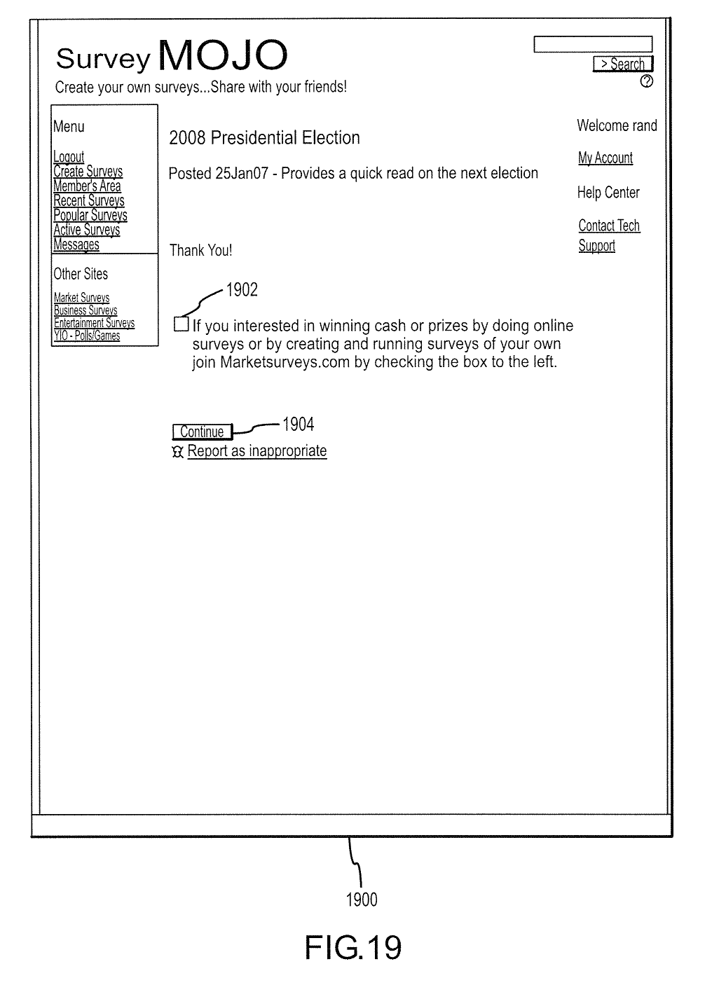

Referring now to FIG. 19, Invitation Page 1900 is shown, which is the last page in a survey created with the survey tool. The survey taker is invited on this page to join the market research company's online survey panel by clicking in Check Box 1902. In this example, as an incentive to join, the survey taker is informed of the chance to win cash or prizes by signing up to take online surveys or by creating and running surveys of their own.

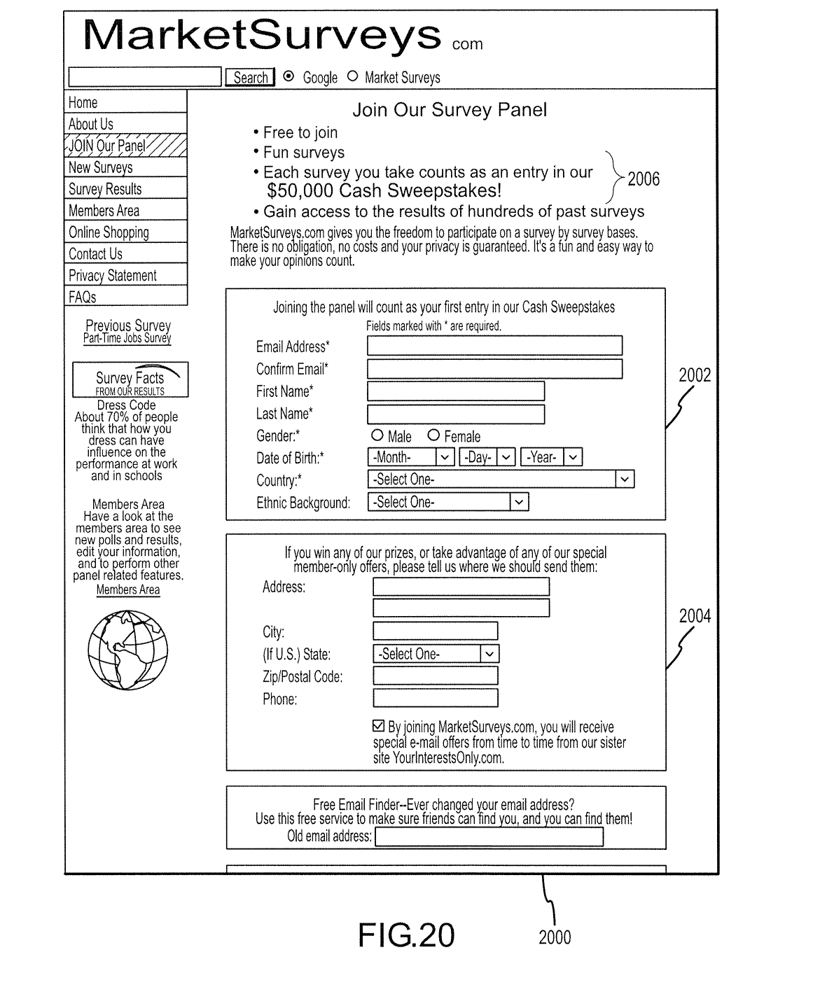

Clicking on Continue Button 1904 will return Join Our Survey Panel Page 2000 to the user's web browser as shown in FIG. 20. Join Our Survey Panel Page 2000 is hosted by the market research company's registration server. Data Input Box 2002 allows the survey taker to enter personal information required for signing up and registering to be an online survey panel member. In this example, the required information includes: email address, first name, last name, gender, date of birth, and country. Data Input Box 2004 allows the survey taker to enter an address where offers or prizes may be sent. Incentive Text 2006 indicates to the survey taker the current incentive being offered by the market research company. This incentive may be changed from time-to-time by the market research company.

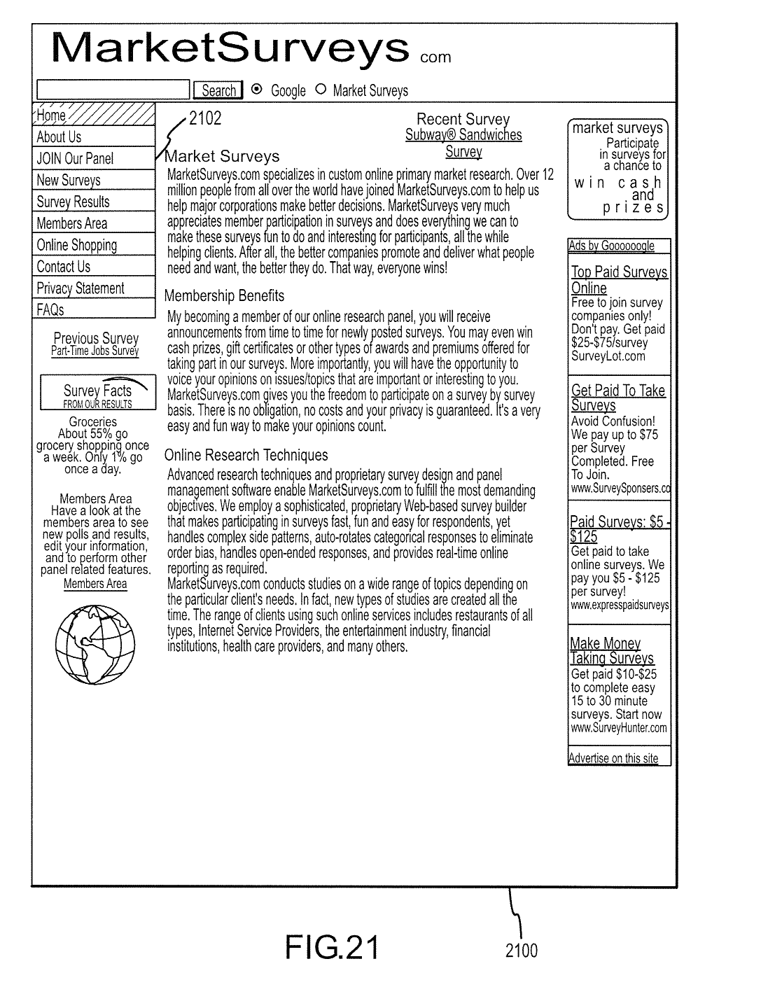

Referring now to FIG. 21, Market Research Home Page 2100 is shown, which is the home page for the market research company. A viewer of this web page may click on Join Our Panel Link 2102, which will return Join Our Survey Panel Page 2000 to the user's web browser as shown in FIG. 20. The viewer can then sign up to join the survey panel as described above in the discussion of FIG. 20.

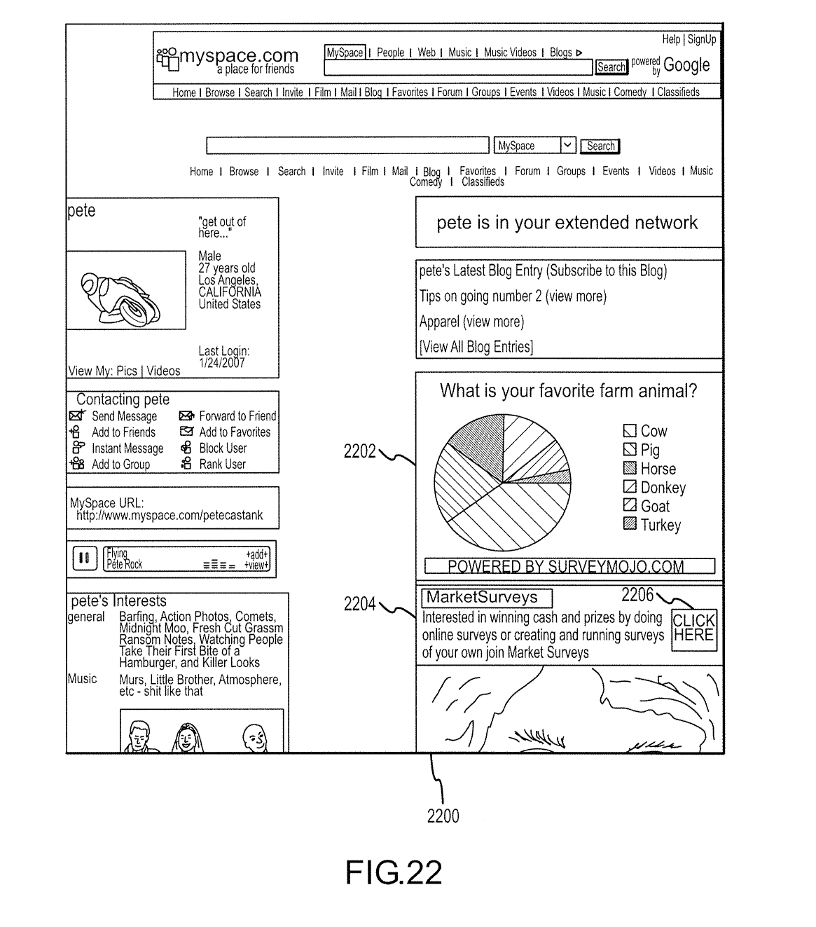

Referring now to FIG. 22, a user who has utilized the survey tool has the results of one of the survey questions posted as Graphic Image 2202 on their social networking or community site Home Page 2200. A viewer of this web page is invited to join the market research company's survey panel in Invitation Box 2204. If the viewer is interested, the viewer may click on Click Here Button 2206, which will return Join Our Survey Panel Page 2000 to the viewer's web browser as shown in FIG. 20. The viewer can then sign up to join the survey panel as described above in the discussion of FIG. 20.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications of the invention will suggest themselves without departing from the scope of the present disclosure.

What is claimed is:

1. A method for recruiting people to join an online survey panel over the Internet, the method comprising the steps of:
(a) offering, by a party, the use of a survey tool for creating online surveys to a plurality of online users through an offer;
(b) inviting, by said party through said offer, said plurality of online users to join the online survey panel;
(c) providing, by said party through said offer, a registration information to said plurality of online users who want to join the online survey panel via a registration server; and
(d) allowing, by said party, access by said plurality of online users to said survey tool.

2. The method according to claim 1 wherein said offering step (a) further comprises at least one of the steps of:
posting said offer on a website of said party;
sending emails about said offer to said plurality of online users;
mailing direct mail pieces about said offer to said plurality of online users;
placing advertisements about said offer on one or more third party websites; and
placing advertisements in newspapers, magazines, billboards, and other print media.

3. The method according to claim 1 wherein said inviting step (b) further comprises the step of:
offering an incentive to said plurality of online users to join the online survey panel.

4. The method according to claim 1 wherein said providing step (c) further comprises the step of:
including a link to a registration web page of said registration server in said offer.

5. The method according to claim 1 wherein said allowing step (d) further comprises at least one of the steps of:
allowing access to said survey tool to said plurality of online users for free;
allowing access to said survey tool to said plurality of online users for a fee;
allowing access to said survey tool to said plurality of online users only after said plurality of online users have registered with said party; and
allowing access to said survey tool to said plurality of online users only after said plurality of online users have joined the online survey panel.

6. The method according to claim 1 wherein said allowing step (d) further comprises at least one of the steps of:
accessing said survey tool by said plurality of online users through a website hosted by a web host server of said party;
downloading software for said survey tool over the Internet from said web host server of said party to said plurality of online users; and
accessing said survey tool by said plurality of online users over a wireless application via a wireless device.

7. The method according to claim 1 further comprising the step of:
creating, by at least one of said plurality of online users, an online survey with said survey tool.

8. The method according to claim 7 further comprising at least one of the steps of:
posting a link to said online survey on a website, blog, or web page on a social network website of said at least one of said plurality of online users;
posting a link to a third party survey on said website, blog, or web page on said social network website of said at least one of said plurality of online users;
sending by said at least one of said plurality of online users a plurality of emails each having said link to said online survey and said link to said third party survey; and
publishing said link to said online survey and said link to said third party survey in an electronic or non-electronic publishing medium.

9. The method according to claim 8 further comprising the steps of:
viewing by a viewer said link to said online survey and said link to said third party survey through a web browser of said viewer or by viewing said link to said online survey and said link to said third party survey on said electronic or non-electronic publishing medium;
clicking by said viewer on said link for said online survey, or clicking on said link to said third party survey, posted on said social network website, or typing in said link for said online survey, or typing in said link to said third party survey, in said web browser of said viewer;
returning to said web browser of said viewer said online survey, or said third party survey;
taking said online survey, or said third party survey, by said viewer;
presenting to said viewer an offer to join the online survey panel through said online survey; and
presenting to said viewer an offer to register with said party through said online survey to gain access to said survey tool or to use said survey tool without registering.

10. The method according to claim 9 further comprising the steps of:
presenting to said viewer an offer to join a third party online survey panel through said third party survey; and
presenting to said viewer a link to a third party website to join said third party online survey panel.

11. The method according to claim 9 further comprising the steps of:
posting a graphic image of a result of at least one survey question from said online survey to said website, blog, or web page on said social network website of said at least one of said plurality of online users, or publishing said graphic image of said result of said at least one survey question from said online survey to said electronic or non-electronic publishing medium; and
posting an invitation to join the online survey panel on said website, blog, or web page on said social network website of said at least one of said plurality of online users, or publishing said invitation to join the online survey panel to said electronic or non-electronic publishing medium, wherein said invitation has a link to a registration web page of said party.

12. The method according to claim 11 further comprising the steps of.
viewing by a subsequent viewer said website, blog, or web page on said social network website of said at least one of said plurality of online users through a web browser of said subsequent viewer or by viewing said link to said online survey on said electronic or non-electronic publishing medium;
clicking by said subsequent viewer on said link for said online survey posted on said website, blog, or web page, or typing in said link to said registration web page in said web browser of said subsequent viewer;
returning to said web browser of said subsequent viewer said online survey;
taking by said subsequent viewer said online survey;
presenting to said subsequent viewer said offer to join the online survey panel through said online survey; and
presenting to said subsequent viewer said offer to register with said party through said online survey to gain access to said survey tool or to use said survey tool without registering.

13. The method according to claim 8 further comprising the steps of:
viewing by a viewer at least one of said plurality of emails having said link for said online survey, and said link to said third party survey, through a web browser of said viewer;
clicking by said viewer on said link for said online survey, or clicking on said link to said third party survey;
returning to said web browser of said viewer said online survey, or said link to said third party survey;
taking by said viewer said online survey, or said link to said third party survey;
presenting to said viewer an offer to join the online survey panel through said online survey; and
presenting to said viewer an offer to register with said party through said online survey to gain access to said survey tool or to use said survey tool without registering.

14. The method according to claim 13 further comprising the steps of:
presenting to said viewer an offer to join a third party online survey panel through said third party survey; and
presenting to said viewer a link to a third party website to join said third party online survey panel.

15. The method according to claim 1 further comprising the step of.
designing said survey tool to allow said plurality of online users to create surveys, quizzes, tests, and polls.

16. The method according to claim 1 wherein said party is at least a one of a company, an individual, an agent for said company, an agent for said individual, and a partnership.

17. The method according to claim 1 wherein said party is a combination of two or more of a company, an individual, an agent for said company, an agent for said individual, and a partnership.

18. A system for recruiting people to join an online survey panel, the system comprising:
a survey tool for creating online surveys;
a web host server for hosting said survey tool on the Internet, and for disseminating, to a plurality of web browsers of a plurality of online users on the Internet, an offer to use said survey tool and to join the online survey panel; and
a registration server for providing registration information over the Internet to said plurality of web browsers of said plurality of online users who want to join the online survey panel.

19. The system according to claim 18 further comprising:
at least one web server, wherein said plurality of online users can create a survey utilizing said survey tool and post a link to said survey on a web page or a blog of said plurality of online users hosted by said at least one web server.

20. The system according to claim 19 further comprising:
at least one third party web host server, wherein said survey tool posts a graphic image of a result of at least one survey question from said survey to said web page or said blog of said plurality of online users, wherein said graphic image contains said link to said survey, a link to a registration web page hosted on said registration server, and a link to a third party survey hosted on said at least one third party web host server, or said survey tool presents said graphic image containing said link to said survey, said link to said registration web page, and said link to said third party survey for publishing via an electronic or non-electronic publishing medium.

21. The system according to claim 20 further comprising:
a plurality of viewer web browsers, wherein a plurality of viewers view said graphic image on said web page or said blog of said plurality of online users, and click on said link to said survey in order to take said survey, or click on said link to said registration web page in order to join the online survey panel and to register to access said survey tool or to use said survey tool without registering, or click on said link to said third party survey in order to take said third party survey.

22. The system according to claim 18 further comprising:
at least one social network web server, wherein said plurality of online users can create a survey utilizing said survey tool and post a link to said survey and a link to a registration web page hosted on said registration server on a home page of said plurality of online users hosted by said at least one social network web server.

23. The system according to claim 22 wherein said survey tool posts a graphic image of a result of at least one survey question from said survey to said home page of said plurality of online users, wherein said graphic image contains said link to said survey and said link to said registration web page hosted on said registration server.

24. The system according to claim 23 further comprising:
a plurality of viewer web browsers, wherein a plurality of viewers view said graphic image on said home page of said plurality of online users, and click on said link to said survey in order to take said survey, or click on said link to said registration web page in order to join the online survey panel and gain access to said survey tool.

25. The system according to claim 18 further comprising:
at least one email server, wherein said plurality of online users can create a survey utilizing said survey tool and include a link to said survey in a plurality of emails sent by said plurality of online users by said at least one email server.

26. The system according to claim 18 wherein said survey tool can be used to create surveys, quizzes, tests, and polls.

27. The system according to claim 18 further comprising:
a plurality of wireless devices of said plurality of online users for accessing said survey tool from said web host server via a wireless application.

28. A method for recruiting an Internet user to join an online survey panel, the method comprising the steps of:
(a) offering the use of a web-based survey tool to the Internet user in exchange for the Internet user joining the online survey panel;
(b) securing demographic information from the Internet user required for the online survey panel; and
(c) granting access to the Internet user to said web-based survey tool through a host web server.

29. The method according to claim 28 further comprising the steps of:
posting a graphic image of a result of at least one survey question from a survey created by the Internet user to a website, blog, or web page on a social network website associated with the Internet user, or publishing said graphic image of said result of said at least one survey question from said survey to an electronic or non-electronic publishing medium; and
posting an invitation to take the survey and to join the online survey panel on said website, blog, or web page on said social network website of the Internet user, or publishing said invitation to take the survey and to join the online survey panel to said electronic or non-electronic publishing medium, wherein said invitation has a link to said survey and a link to a registration web page hosted on a registration server.

30. The method according to claim 29 further comprising the steps of:
viewing by a viewer said website, blog, or web page on said social network website associated with the Internet user through a web browser of said viewer or by viewing said graphic image and said invitation on said electronic or non-electronic publishing medium;
clicking by said viewer on said link for said survey or said link to said registration web page posted on said website, blog, or web page, or typing in said link to said survey or said link to said registration web page in said web browser of said viewer;
returning to said web browser of said viewer said survey, or said registration web page by said host web server; and
taking by said viewer said survey, or registering through said registration web page.

31. The method according to claim 29 further comprising the steps of:
viewing by a viewer said invitation to join the online survey panel on said website, blog, or page on said social network website associated with the Internet user through a web browser of said viewer, or by viewing said invitation to join the online survey panel on said electronic or non-electronic publishing medium;
clicking by said viewer on said link to said registration web page posted on said website, blog, or web page, or typing in said link to said registration web page in said web browser of said viewer;
returning to said web browser of said viewer said registration web page by said registration server; and
receiving registration information from said viewer through said registration web page.

32. A method for recruiting an Internet user to join an online survey panel, the method comprising the steps of:
viewing by the Internet user a website, blog, or web page on a social network website that has posted therein a graphic image of a result of at least one survey question from an online survey, along with a link to take said online survey;
clicking by the Internet user on said link for taking said online survey;
taking said online survey by the Internet user; and
viewing by the Internet user through said online survey an offer to join the online survey panel.

33. The method according to claim 32 further comprising the steps of:
clicking by the Internet user on a link in said offer to join the online survey panel;
viewing by the Internet user a registration web page; and
entering by the Internet user a plurality of demographic information in said registration web page.
